(19) United States
(12) Patent Application Publication
(10) Pub. No.: US 2018/0158401 A1
(43) Pub. Date: Jun. 7, 2018

(54) A DRIVING SYSTEM FOR A DISPLAY DEVICE, AND DRIVING CIRCUIT APPLICABLE TO OLED

(71) Applicant: Shenzhen China Star Optoelectronics Technology Co. Ltd., Shenzhen (CN)

(72) Inventors: Zhenling WANG, Shenzhen (CN); Tai Jiun HWANG, Shenzhen (CN)

(73) Assignee: Shenzhen China Star Optoelectronics Technology Co. Ltd., Shenzhen (CN)

(21) Appl. No.: 14/897,696

(22) PCT Filed: Oct. 10, 2015
(86) PCT No.: PCT/CN2015/091673

§ 371 Date: Dec. 27, 2017

(30) Foreign Application Priority Data
Sep. 15, 2015 (CN) 201510583321.3

(51) Int. Cl. G09G 3/3225

(52) U.S. Cl. CPC G09G 3/3225; G09G 2320/045; G09G 2320/0238; G09G 2310/027; G09G 2320/0233; G09G 2320/0673

(57) ABSTRACT

Provided is a driving system for a display device and a driving circuit applicable to an OLED, which belong to the field of display technology, and can eliminate the phenomenon of shortening in lifetime of the OLED caused by a long-term DC bias light-emitting state of the OLED.

### CROSS-REFERENCE TO RELATED APPLICATIONS

The present application claims the priority of Chinese patent application CN 201510583321.3, entitled “A driving system for a display device, and a driving circuit applicable to OLED” and filed on Sep. 15, 2015, the entirety of which is incorporated herein by reference.

### FIELD OF THE INVENTION

The present disclosure relates to the field of display technologies, and in particular, to a driving system for a display device, and a driving circuit applicable to an OLED.

### BACKGROUND OF THE INVENTION

In the prior art, during a display procedure of an organic light-emitting diode (OLED for short) display device, an electric field of a long-time loaded DC driving voltage causes polarization of OLED internal ions, and formation of a built-in electric field, which increases an OLED threshold voltage, greatly reduces luminous efficiency of the OLED, and shortens lifetime of the OLED.

As shown in FIG. 1, an existing 2T1C pixel unit driving circuit includes an input transistor T₁, a storage capacitor C_{S}, and a driving transistor T₂. In FIG. 1, T₁ and T₂ are n-type transistors; V_{SCAN} and V_{DATA} are respectively a scan voltage and a data voltage; T₂ is used to drive the OLED; and V_{DD} and V_{SS} are respectively a high level and a low level.

During operation of the 2T1C pixel unit driving circuit as shown in FIG. 1, when V_{SCAN} is at a high level, data voltage V_{DATA} is applied to T₂ through T₁, to activate T₂. At this time, an anode of the OLED has a potential of (V_{DATA}-Vₜₕ-V_{OLED}), wherein Vₜₕ is a threshold voltage of T₂, and V_{OLED} is a voltage difference between the anode and a cathode of the OLED. When V_{SCAN} is at a low level, a voltage stored in C_{S} can still activate T₂.

It can be seen from the above, the 2T1C pixel unit driving circuit as shown in FIG. 1, after being applied with data voltage V_{DATA} through a data line, will be in a light-emitting display state during one whole frame of time. A long-term DC bias light-emitting state of the OLED accelerates polarization of organic materials, thereby enhancing the built-in electric field of the OLED, increasing the OLED threshold voltage, remarkably reducing the luminous efficiency of the OLED, and shortening the lifetime of the OLED.

### SUMMARY OF THE INVENTION

It is an object of the present disclosure to provide a driving system for a display device, and a driving circuit applicable to an OLED, thereby eliminating a phenomenon of shortening in lifetime of the OLED caused by a long-term DC bias light-emitting state of the OLED.

According to a first aspect of the present disclosure, a driving circuit applicable to an OLED is provided, which includes a driving unit connected to a scan line and a data line for driving the OLED, and a reverse bias unit connected to the OLED, wherein the reverse bias unit is used for controlling reverse bias of the OLED when a black picture is inserted between two image frames.

Optionally, the driving unit includes a first transistor, a second transistor, and a storage capacitor. An output terminal of the first transistor is connected to a first terminal of the storage capacitor and a control terminal of the second transistor; a second terminal of the storage capacitor is connected to a first driving signal; and an output terminal of the second transistor is connected to an anode of the OLED, a cathode of which is connected to a cathode driving signal.

Optionally, the cathode driving signal is switched between a first level and a second level. The first level is equal to a high level of the first driving signal, and higher than the second level.

Optionally, the reverse bias unit includes a third transistor and a fourth transistor. The third transistor has a control terminal, an input terminal, and an output terminal respectively connected to a first control signal, a second terminal of the storage capacitor, and an input terminal of the second transistor. The fourth transistor has a control terminal, an input terminal, and an output terminal respectively connected to a second control signal, the anode of the OLED, and a second driving signal. The second driving signal has an amplitude lower than that of the first driving signal, but higher than that of a signal connected to the control terminal of the second transistor.

The second transistor and the OLED are reversely biased when the third transistor and the fourth transistor are respectively deactivated and activated, and the cathode driving signal is at the second level.

The present disclosure brings about the following beneficial effects. In the embodiment of the present disclosure, the reverse bias unit controls the reverse bias of the OLED when the black picture is inserted between two frames, thereby not only eliminating the residual electric charge in the OLED, to extend the lifetime of the OLED, but also ensuring that the OLED reverse bias does not affect the display effect of the display device.

According to a second aspect of the present disclosure, a driving system of a display device is provided, which comprises the above driving circuit, and further comprises:

a processing unit, which caches a data signal from a signal source, performs frame multiplication on the data signal by insertion of a black picture between two adjacent data signal frames, and outputs a frame multiplied data signal to a display panel; and

a control unit, which outputs a reverse bias signal when the processing unit outputs a data signal corresponding to the black picture,

wherein the reverse bias unit of the driving circuit is configured to control reverse bias of the OLED and a driving transistor according to the reverse bias signal.

Optionally, the reverse bias signal comprises a first control signal and a second control signal. The first control signal is supplied to a control terminal of a third transistor in the reverse bias unit, and the second control signal is supplied to a control terminal of a fourth transistor.

Optionally, the first control signal and the second control signal have a same frequency and opposite phases.

Optionally, the reverse bias signal further comprises a cathode driving signal which is switched between a first level and a second level, the first level being higher than the second level. The cathode driving signal is at a high level when the processing unit outputs the data signal corresponding to the black picture.

Optionally, the driving system further comprises:

an analysis unit, which analyzes an average image level frame-by-frame; and

a gamma voltage unit, which outputs a first gamma voltage when the average image level output from the analysis unit is higher than a preset value, or otherwise, outputs a second gamma voltage which is higher than the first gamma voltage.

Other features and advantages of the present disclosure will be set forth in the description which follows and, in part, will be obvious from the description, or may be learned by practice of the present disclosure. The objectives and other advantages of the present disclosure may be realized and attained by the structure particularly pointed out in the description, claims and drawings.

### BRIEF DESCRIPTION OF THE DRAWINGS

In order to explicitly illustrate the technical solution of the embodiments of the present disclosure, the embodiments will be described in combination with accompanying drawings, in which:

FIG. 1 is a schematic structural view of an existing driving circuit;

FIG. 2 is a schematic structural view of a driving circuit according to an embodiment of the present disclosure;

FIG. 3 is a specific diagram of a driving circuit in an embodiment of the present disclosure;

FIG. 4 is an equivalent diagram of FIG. 3;

FIG. 5 is a schematic structural view of a driving system according to an embodiment of the present disclosure; and

FIG. 6 is a signal diagram in an embodiment of the present disclosure.

### DETAILED DESCRIPTION OF THE EMBODIMENTS

The present disclosure will be explained in detail with reference to the embodiments and the accompanying drawings, whereby it can be fully understood how to solve the technical problem by the technical means according to the present disclosure and achieve the technical effects thereof, and thus the technical solution according to the present disclosure can be implemented. It is important to note that as long as there is no structural conflict, all the technical features mentioned in all the embodiments may be combined together in any manner, and the technical solutions obtained therefrom all fall within the scope of the present disclosure.

### Example 1

A driving circuit applicable to an OLED is provided in an embodiment of the present disclosure. As shown in FIG. 2, the driving circuit includes a driving unit connected to a scan line and a data line for driving the OLED, and a reverse bias unit connected to the OLED.

In the prior art, the OLED is always in a DC bias light-emitting state. That is, a potential of an anode of the OLED is higher than that of a cathode thereof. This easily enhances a built-in electric field of the OLED and increases an OLED threshold voltage, thereby greatly reducing the luminous efficiency and shortening the lifetime of the OLED.

In order to eliminate the built-in electric field of the OLED, it is necessary to reverse-bias the OLED. However, if the OLED is in a reverse bias state, it will not emit light smoothly. Thus an entire display device will enter a black screen state. Therefore, in the embodiment of the present disclosure, the reverse bias unit controls reverse-bias of the OLED when a black picture is inserted between two image frames, thereby ensuring that the reverse-bias of the OLED does not affect the display effect of the display device.

Specifically, as shown in FIG. 3, the driving unit includes a first transistor T₁, a second transistor T₂, and a storage capacitor C_{S}. An output terminal of the first transistor T₁ is connected to a first terminal of the storage capacitor C_{S} and a control terminal of the second transistor T₂. A second terminal of the storage capacitor C_{S} is connected to a first driving signal V₁, and an output terminal of the second transistor T₂ is connected to the anode of the OLED, the cathode of which is connected to a cathode driving signal V₂.

And the reverse bias unit includes a third transistor T₃ and a fourth transistor T₄, wherein the third transistor T₃ has a control terminal, an input terminal, and an output terminal respectively connected to a first control signal Ctrl1, a second terminal of the storage capacitor C_{S}, and an input terminal of the second transistor T₂; and the fourth transistor T₄ has a control terminal, an input terminal, and an output terminal respectively connected to a second control signal Ctrl2, the anode of the OLED and, a second driving signal V₂.

Further, an amplitude of the second driving signal V₂ is smaller than that of the first driving signal V₁ and greater than that of a signal connected to the control terminal of the second transistor T₂.

It should be noted that a high level of the first driving signal V₁ in FIG. 3 is equal to a high level V_{DD} in the prior art. And the cathode driving signal V₂ is switched between a first level and a second level, wherein the first level is higher than the second level. Specifically, a volt value of the first level is equal to that of the high level V_{DD} in the prior art, and a volt value of the second level is equal to a low level V_{SS} in the prior art.

In the embodiment of the present disclosure, the first control signal Ctrl1 and the second control signal Ctrl2 are respectively used to drive the third transistor T₃ and the fourth transistor T₄. The third transistor T₃ is provided so as to disconnect the input terminal of the second transistor T₂ from the first driving signal V₁, and the fourth transistor T₄ is provided to allow the OLED to be in a reverse bias state when the third transistor T₃ disconnects the input terminal of the second transistor T₂ from the first driving signal V₁. When the third transistor T₃ connects the input terminal of the second transistor T₂ to the first driving signal V₁, the fourth transistor T₄ must be disconnected from the OLED, or otherwise the OLED will not emit light normally, thus affecting the display effect of the display device.

Since the third transistor T₃ and the fourth transistor 14 are in a state in which one of them is turned off and the other is turned on, the first control signal Ctrl1 and the second control signal Ctrl2 respectively driving the third transistor T₃ and the fourth transistor T₄ should be of a same frequency, but in opposite phases, as shown in FIG. 6.

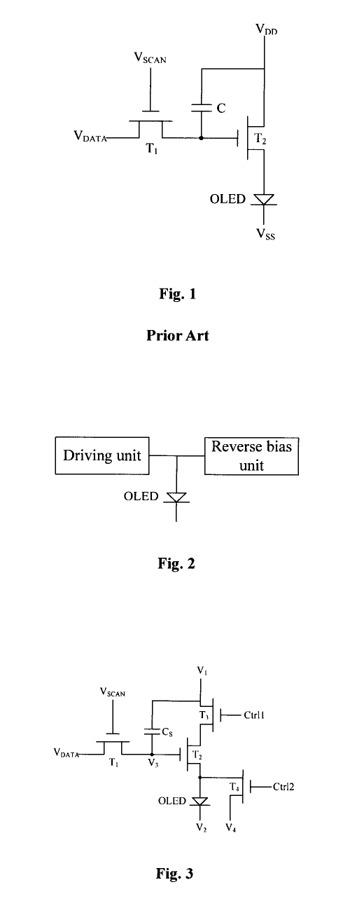

Specifically, when the first control signal Ctrl1 and the second control signal Ctrl2 are respectively at a high level and a low level, the third transistor T₃ is turned on and the fourth transistor 14 is turned off. And at this time, the cathode driving signal V₂ is at a low level, so that the display device can display a normal picture. In this case, the driving circuit shown in FIG. 3 has an equivalent circuit as shown in FIG. 1.

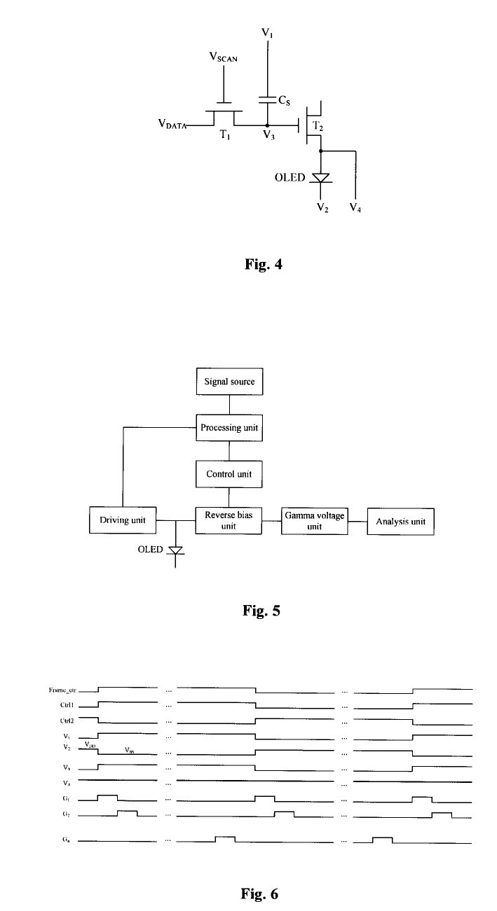

When the first control signal Ctrl1 and the second control signal Ctrl2 are respectively at the low level and the high level, the third transistor T₃ and the fourth transistor T₄ are respectively turned off and turned on. And at this time, the cathode driving signal V₂ is at a high level. Obviously, the equivalent circuit of FIG. 3 at this moment is shown in FIG. 4. Since the third transistor T₃ is turned off, and the level of the cathode driving signal V₂ is higher than that of the second driving signal V₄, which is at the same time higher than a voltage V₃ of the control terminal of the second transistor T₂, the OLED does not emit light and is in a reverse bias state together with the second transistor T₂. This can cancel residual charge in the second transistor T₂ and the OLED, thereby suppressing shift of a threshold voltage in the second transistor T₂, and meanwhile extending lifetime of the OLED.

### Example 2

The present embodiment provides a driving system of a display device, which includes, as shown in FIG. 5, a driving circuit as shown in FIG. 2, and further comprises:

a processing unit, which buffers a data signal from a signal source, performs frame multiplication on the data signal by insertion of a black picture between adjacent two data signal frames, and outputs frame multiplied data signal to a display panel.

The principle of frequency multiplication technology is to add a black picture frame between two conventional image frames, so as to increase a refresh rate of an ordinary display device from 60 Hz up to 120 Hz, and increase a display signal thereof from previous 60 frames per second up to now 120 frames per second, thus effectively solving the problems such as image blurring and smearing generated during play of motion pictures by the display device. This is favorable for clearing an image blur from a previous frame to improve a dynamic clarity effect, and for reducing image smearing to a degree that are difficult for human eyes are to perceive.

Specifically, the processing unit comprises a single frame memory module and a dual frame memory module. When the display device starts to work, the signal source outputs a first frame picture signal, and the processing unit receives the first frame picture signal and stores it in the single frame memory module. When the signal source outputs a second frame picture signal, the processing unit receives a second frame picture signal and stores it in the dual frame memory module. The single frame memory module and the dual frame memory module output picture signals in turn.

The processing unit also includes a black picture generating module for generating a black picture signal.

As shown in FIG. 5, the driving system further includes a control unit for outputting a control signal, which controls output of a picture signal or a black picture by a signal processor, and outputs a reverse bias signal when the control unit outputs a data signal corresponding to the black picture.

Further, the reverse bias unit in the driving circuit is used for controlling the reverse bias of the OLED and the driving transistor in accordance with the reverse bias signal.

In order to drive the reverse bias unit, the reverse bias signal includes a first control signal and a second control signal, which are respectively supplied to the control terminal of the third transistor and the control terminal of the fourth transistor in the reverse bias unit. In addition, the reverse bias signal further comprises a cathode driving signal which is switched between a first level and a second level, the first level being higher than the second level. When the processing unit outputs a data signal corresponding to the black picture, the cathode driving signal will be at a high level.

Specifically, as shown in FIG. 6, when the control unit outputs a control signal Frame_ctrl at the high level, the processing unit will output the picture signal; the first control signal Ctrl1 and the second control signal Ctrl2 will be respectively at the high level and the low level; the first driving signal V₁ will be at the high level; the cathode driving signal V₂ will be equal to V_{SS}; V₃ will be at the high level; and the second driving signal V₄ will be a constant value. Gate lines from G₁ to Gₙ of the display device will then start scanning line by line, to display pictures output by the processing unit on the display device.

When the control unit outputs the control signal Frame_ctrl at the low level, the processing unit will output the black picture signal; the first control signal Ctrl1 and the second control signal Ctrl2 will be respectively at the low level and the high level; the first driving signal V₁ will be at the low level; the cathode driving signal V₂ will be equal to V_{DD}; V₃ will be at the low level; and the second driving signal V₄ will be a constant value. The gate lines from G₁ to Gₙ of the display device will then start scanning line by line, to display the black picture output by the processing unit on the display device. The second transistor T₂ and the OLED in the driving circuit will enter a reverse bias state.

Further, since the frame multiplication procedure is realized by insertion of the black frame in the present embodiment, there is a possibility that the picture brightness will be lowered. In order to ensure a proper brightness and a satisfactory display effect of the display device, as shown in FIG. 5, the driving module provided in the present embodiment further comprises an analysis unit and a gamma voltage unit. Therein, the analysis unit is configured to analyze an average picture level (APL) on a frame-by-frame basis; and the gamma voltage unit will output a first gamma voltage when the APL output by the analysis unit is higher than a preset value (e.g., 0.3), or otherwise, output a second gamma voltage, the first gamma voltage being lower than the second gamma voltage.

Although the embodiments of the present disclosure have been described above, the description is merely for the purpose of facilitating the understanding of the present disclosure and is not intended to limit the present disclosure. It should be understood by those skilled in the art that various changes in form and details may be made therein without departing from the spirit and scope of the present disclosure. It is intended that the scope of protection of the disclosure should be determined within the scope of the claims appended hereto.

1. A driving circuit applicable to an OLED, which includes a driving unit connected to a scan line and a data line for driving the OLED, and a reverse bias unit connected to the OLED,
wherein the reverse bias unit is used for controlling reverse bias of the OLED when a black picture is inserted between two image frames.

2. The driving circuit according to claim 1, wherein the driving unit includes a first transistor, a second transistor, and a storage capacitor,
wherein an output terminal of the first transistor is connected to a first terminal of the storage capacitor and a control terminal of the second transistor;
wherein a second terminal of the storage capacitor is connected to a first driving signal; and
wherein an output terminal of the second transistor is connected to an anode of the OLED, a cathode of which is connected to a cathode driving signal.

3. The driving circuit according to claim 2, wherein the cathode driving signal is switched between a first level and a second level,
wherein the first level is equal to a high level of the first driving signal, and higher than the second level.

4. The driving circuit according to claim 3, wherein the reverse bias unit includes a third transistor and a fourth transistor,
wherein the third transistor has a control terminal, an input terminal, and an output terminal respectively connected to a first control signal, a second terminal of the storage capacitor, and an input terminal of the second transistor,
wherein the fourth transistor has a control terminal, an input terminal, and an output terminal respectively connected to a second control signal, the anode of the OLED, and a second driving signal,
wherein the second driving signal has an amplitude lower than that of the first driving signal, but higher than that of a signal connected to the control terminal of the second transistor, and
wherein the second transistor and the OLED are reversely biased when the third transistor and the fourth transistor are respectively deactivated and activated, and the cathode driving signal is at the second level.

5. A driving system of a display device, the driving system comprising a driving circuit, which includes a driving unit connected to a scan line and a data line for driving the OLED, and a reverse bias unit connected to the OLED, wherein the reverse bias unit is used for controlling reverse bias of the OLED when a black picture is inserted between two image frames; and the driving system further comprising:
a processing unit, which caches a data signal from a signal source, performs frame multiplication on the data signal by insertion of a black picture between two adjacent data signal frames, and outputs a frame multiplied data signal to a display panel; and
a control unit, which outputs a reverse bias signal when the processing unit outputs a data signal corresponding to the black picture,
wherein the reverse bias unit of the driving circuit is configured to control reverse bias of the OLED and a driving transistor according to the reverse bias signal.

6. The driving system according to claim 5, wherein the reverse bias signal comprises a first control signal and a second control signal,
wherein the first control signal is supplied to a control terminal of a third transistor in the reverse bias unit, and the second control signal is supplied to a control terminal of a fourth transistor.

7. The driving system according to claim 6, wherein the first control signal and the second control signal have a same frequency and opposite phases.

8. The driving system according to claim 5, wherein the reverse bias signal further comprises a cathode driving signal which is switched between a first level and a second level, the first level being higher than the second level; and
wherein the cathode driving signal is at a high level when the processing unit outputs the data signal corresponding to the black picture.

9. The driving system according to claim 5, further comprising:
an analysis unit, which analyzes an average image level frame-by-frame; and
a gamma voltage unit, which outputs a first gamma voltage when the average image level output from the analysis unit is higher than a preset value, or otherwise, outputs a second gamma voltage which is higher than the first gamma voltage.
